(19) United States
(12) Patent Application Publication
(10) Pub. No.: US 2007/0098373 A1
(43) Pub. Date: May 3, 2007

(54) Dc motor drive unit

(76) Inventors: Koichi Saito, KYOTO (JP); Tomotake Sato, Kyoto (JP)

Correspondence Address: HOGAN & HARTSON L.L.P., 1999 AVENUE OF THE STARS, SUITE 1400, LOS ANGELES, CA, 90067, US

(21) Appl. No.: 10/578,219

(22) PCT Filed: Nov. 29, 2004
(86) PCT No.: PCT/JP04/18074

§ 371 Date: May 3, 2006

(30) Foreign Application Priority Data
Dec. 1, 2003 (JP) 2003-401348

(51) Int. Cl. H02P 7/29

(52) U.S. Cl. 388/811

(57) ABSTRACT

In a DC motor drive unit having an open loop control system, a judgment is made as to whether an externally supplied speed instruction data instructs driving of the DC motor or not, based on the speed instruction data itself. If a judgment is made that the speed instruction data instructs driving of the DC motor, a switching means (e.g. switching transistor) connected to the DC motor is controlled by PWM pulses having prescribed duty ratios over a predetermined acceleration period to accelerate the DC motor. After the acceleration period, the switching means is controlled by the PWM pulses having a duty ratio as instructed by the speed instruction data to drive the DC motor. This scheme permits suppression of the startup current of the motor, and hence reduction of the withstand current of the switching transistor, while ensuring secure startup of the motor. In addition, the range of controllable speed of the DC motor can be broadened.

### TECHNICAL FIELD

This invention relates to a direct-current (DC) motor drive unit capable of securely starting up the motor with suppressed startup current and running the motor at the speed in accord with an external speed instruction.

### BACKGROUND ART

Motors are used in game controllers and toys to drive or vibrate their moving parts. Mostly, DC motors are used for this purpose for the reason that they can be powered by batteries and their drive circuits are simple in structure.

FIG. 5 shows a circuit arrangement of a widely used conventional DC motor drive circuit having an open loop control system. As shown in FIG. 5, a DC motor 1 is connected between a power supply voltage Vcc and the ground via a switching transistor 2 for switching on/off the motor. Since the speed of the DC motor 1 is proportional to the current I flowing through it, the DC motor 1 can be driven at a predetermined speed by controlling on-off operation of the switching transistor 2 using a drive control IC 4 providing pulse width modulation (PWM) pulses. A resistor 3 is provided to adjust the base current of the transistor 2.

In the DC motor drive circuit shown in FIG. 5, exceedingly large startup current Ip will flow through the motor 1 at its startup starting at time t0. In the example shown in FIG. 6, the level of the startup current is more than three times larger than the stationary current level Ic. Therefore, it is necessary to configure the transistor 2 and the power source to withstand such large startup current level Ip, which raises the cost of the drive circuit.

To rotate the motor 1 at a low speed, the duty ratio of the PWM pulses must be reduced. Since the startup current is reduced in accordance with the duty ratio, a startup failure can take place if the startup current is too small to generate a necessary startup torque. Therefore, it is not possible to arbitrarily set the minimum rotational frequency of the DC motor 1, so that the range of controllable speed of the motor is limited.

As a solution for reducing the startup current of such a DC motor as stated above, Japanese Patent Application Laid Open No.H11-230045 (referred to as Patent Document 1) discloses a method of reducing the startup current of a DC motor in which a bias current, small enough not to rotate the motor, is passed through it even when the motor is not in operation.

In the method of Patent Document 1, the startup current can be sufficiently lowered. However, the motor consumes wasteful electric power since the motor is provided with current even when it is not in operation. Moreover, in the method of the Patent Document 1, the range of the rotational speed of the DC motor that can be regulated by adjusting the duty ratio of the PWM pulses is limited like the conventional drive circuit shown in FIG. 5, due to the fact that a bias current, though it is small enough not to rotate the motor, is flowing through the switching transistor.

It is, therefore, an object of the present invention to provide a DC motor drive unit having an open-loop control system, capable of ensuring startup of the motor with sufficiently reduced startup current, thereby allowing not only reduction of the withstand voltage of the switching transistor used, but also broadening of the range of controllable rotational speed of the motor.

### DISCLOSURE OF THE INVENTION

A DC motor drive unit of the invention for driving a DC motor, adapted to control switching means connected in series to the DC motor, comprises:

acceleration setting means for setting a predetermined acceleration period and acceleration stage data in association with the acceleration period at the time of startup of the DC motor; and

means for generating PWM pulses (hereinafter referred to as PWM pulse generation means) having duty ratios in accord with the acceleration stage data or in accord with a prescribed rotational speed of the motor, wherein

the switching means is controlled by
the PWM pulses having duty ratios in accord with the acceleration stage data during the predetermined acceleration period; and
the PWM pulses having the duty ratio in accord with the prescribed rotational speed after the predetermined acceleration period.

The DC motor drive unit of the invention may further comprise a data judgment means for judging whether or not an externally supplied speed instruction data instructs driving of the DC motor. When a judgment is made that the speed instruction data instructs driving of the motor, the switching means is controlled by the PWM pulses having duty ratios in accord with the acceleration stage data during the predetermined acceleration period, but, after the acceleration period, controlled by the PWM pulses having a duty ratio in accord with the rotational speed instructed by the speed instruction data.

The acceleration period may include a sequence of N (N≧1) acceleration stages each set to have PWM pulses of a predetermined duty ratio over a predetermined acceleration time in such a way that the duty ratio increases in the successive acceleration stages.

The DC motor drive unit may be adapted to: measure the time that has elapsed from the beginning of the sequence of acceleration period to determine the current stage in the acceleration period; and determine the duty ratio associated with the stage and/or the duty ratio associated with the speed instruction data in accordance with a lookup table.

Further, the DC motor drive unit may be adapted to execute acceleration of the motor in the acceleration period only if a determination is made that the speed instruction data instructs driving of the DC motor and the DC motor is not in operation.

The DC motor drive unit may be adapted to stop the DC motor if a judgment is made that the speed instruction data does not instruct driving of the DC motor.

As described above, a DC motor drive unit of the invention sets up a predetermined acceleration period in which switching means (e.g. a switching transistor), connected to a DC motor having an open loop control system, is controlled by PWM pulses of predetermined duty ratios at the time of startup of the DC motor, which permits suppression of the startup current of the motor, and hence reduction of the withstand current of the switching means and the cost of the DC motor drive unit while ensuring secure startup of the motor.

The invention sets up N (N≧1) acceleration stages in the acceleration period, with each stage having a predetermined acceleration time (duration) and a prescribed duty ratio of PWM pulses in such a way that the duty ratio increases in the successive stages, which enables quick startup while suppressing the startup current of the motor.

Moreover, since the DC motor is driven by PWM pulses of predetermined duty ratios during the acceleration period and by PWM pulses of a duty ratio based on speed instruction data after the acceleration period, the startup capability of the DC motor is improved and the minimum permissible rotational speed of the motor can be reduced. That is, the motor can be securely started up at all times, and the range of controllable speed of the motor after the startup can be broadened.

In addition, since driving instruction, rotational speed instruction, and stopping instruction for the motor can be discerned based on the magnitude of the speed instruction data supplied to the DC motor drive unit, an upstream or superior control unit can give the motor drive unit instructions on different drive conditions by simply sending the speed instruction data to the motor drive unit.

### BRIEF DESCRIPTION OF THE DRAWINGS

FIG. 1 shows an arrangement of a DC motor drive unit in accordance with one embodiment of the invention.

FIG. 2 is a flowchart describing operation of the DC motor drive unit of FIG. 1.

FIG. 3 is a graph showing an exemplary operational scheme of the DC motor drive unit shown in FIG. 1.

FIG. 4 is a graph showing another exemplary operational scheme of the DC motor drive unit shown in FIG. 1.

FIG. 5 shows an arrangement of a conventional DC motor drive unit.

FIG. 6 is a graph showing an operational scheme of the conventional DC motor drive unit.

### BEST MODE FOR CARRYING OUT THE INVENTION

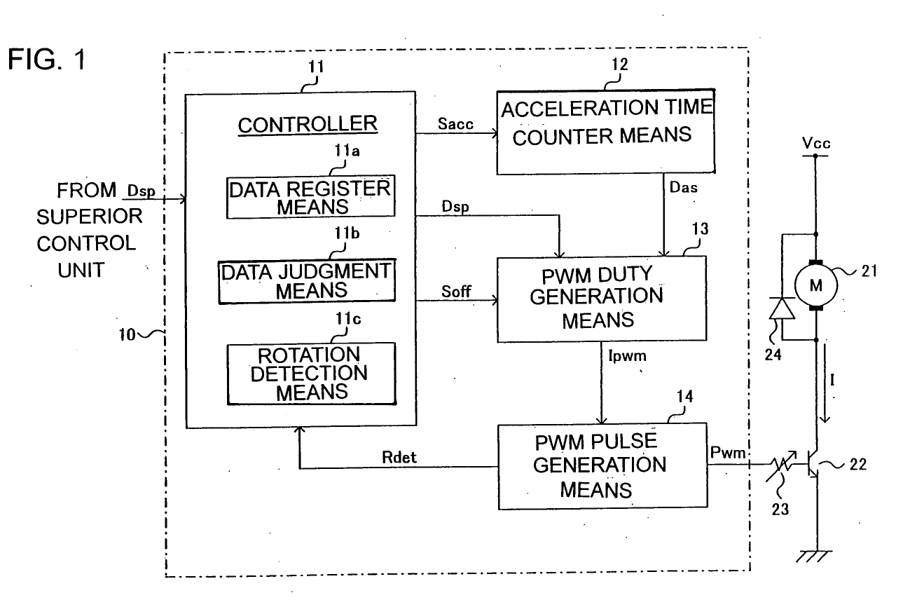

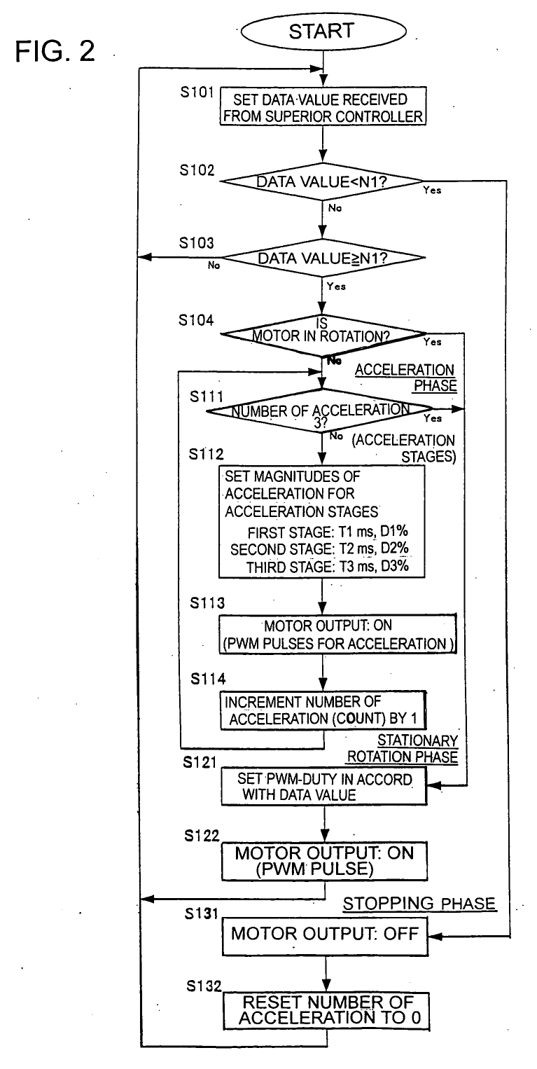

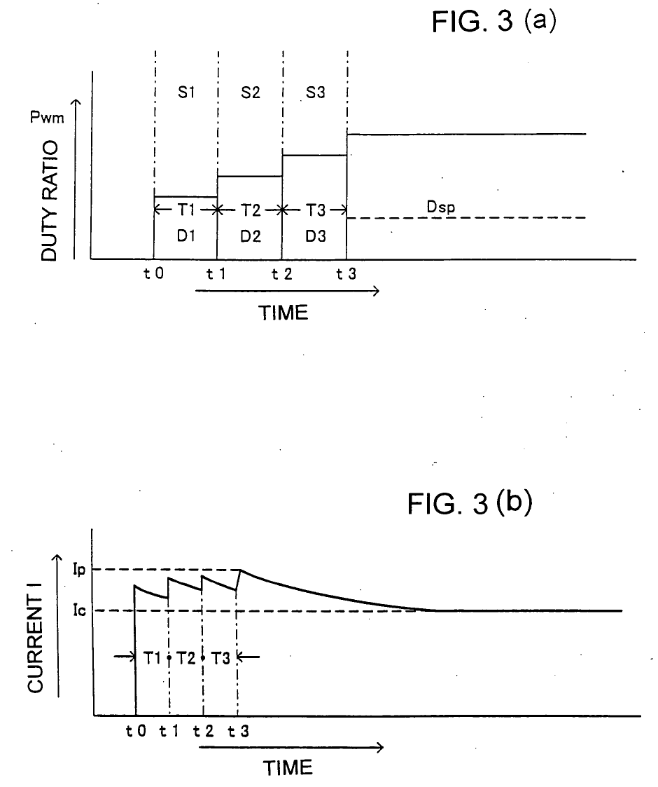

An inventive DC motor drive unit will now be described in detail by way of example with reference to the accompanying drawings. FIG. 1 is a block diagram showing a circuit arrangement of a DC motor drive unit 10 in accordance with one embodiment of the invention. FIG. 2 is a flowchart describing the operation of the circuit shown in FIG. 1. FIG. 3 shows an exemplary operative condition of the DC motor drive circuit shown in FIGS. 1 and 2.

The DC motor drive unit of FIG. 1 is controlled by an open loop control system. A DC motor 21 and a switching transistor 22 are connected between a power supply voltage Vcc and the ground. The switching transistor 22 has a base, which is supplied with PWM pulses Pwm from the motor drive control circuit 10 to turn on and off the switching transistor 22. An adjustment resistor 23 is a variable resistor for adjusting the base current of the transistor 22. The resistor 23 is provided as needed. A free wheel diode 24 is provided to restore electric power or to reduce noises, so that the diode can be omitted if it is necessary to reduce the cost of the circuit.

Through the DC motor 21 flows current I, the magnitude of which depends on the on-off duty ratio of the switching transistor 22. In a stationary state operation where the DC motor 21 is driven to rotate at a fixed speed, the on-off duty ratio of the switching transistor 22 is controlled by the duty ratio of the PWM pulses Pwm. At the time of startup, however, an exceedingly larger current than stationary current will flow through the motor, as is the case with conventional drive units, unless the startup current is limited. Thus, the invention limits the startup current to ensure reduction of the withstand current of the switching transistor 22 while ensuring secure startup of the motor, whereby broadening the range of controllable speed of the motor.

The motor drive control circuit 10 is supplied from a superior control unit with speed instruction data Dsp instructing the rotational speed of the DC motor 21. The superior control unit includes a CPU serving as, for example, a game controller and a main control unit for a toy. The superior control unit provides speed instruction data Dsp for controlling startup, rotational speed, and stopping of the DC motor 21.

The motor drive control circuit 10 has: a controller 11 that includes data register means 11a, data judging means 11b, and rotation detection means 11c; acceleration setting means (hereinafter also referred to as acceleration time counting means) 12 adapted to count, upon receipt of an acceleration instruction signal Sacc, the time that has elapsed since the beginning of the acceleration period to determine the current acceleration stage and output relevant acceleration stage data Das for the acceleration stage; PWM duty generation means 13 for generating a pulse generation signal Ipwm for establishing PWM pulses, the PWM duty generation means 13 being supplied with speed instruction data Dsp, an acceleration stage data Das, and a stop instruction signal Soff; and PWM pulse generation means 14 for generating PWM pulses Pwm upon receipt of a pulse generation signal Ipwm and for supplying the PWM pulses Pwm to the switching transistor 22.

The data register means 11a can store speed instruction data Dsp in a readable form, and updates the stored speed instruction data Dsp every time new speed instruction data Dsp are supplied from the superior controller.

The data judging means 11b reads out speed instruction data Dsp from the data register means 11a and, based on the speed instruction data Dsp, judges whether the speed instruction data Dsp instructs driving of the DC motor 21. For example, if the speed instruction data Dsp exceeds a predetermined value, the data judging means 11b makes a judgment that the speed instruction data Dsp instructs driving of the motor, but otherwise makes a judgment that the data does not instruct driving.

When the speed instruction data Dsp is judged as instructing drive, the data Dsp is supplied to the PWM duty generation means 13, or, at the time of startup, an acceleration instruction signal Sacc is supplied to the acceleration time counting means 12. When the speed instruction data Dsp is judged not instructing driving, a stop instruction signal Soff is supplied to the PWM duty generation means 13 to stop the DC motor 21. It is noted that the function of the stop instruction signal Soff can be substituted for by the speed instruction data Dsp supplied to the PWM duty generation means 13 and/or the acceleration instruction signal Sacc supplied to the acceleration time counting means 12.

When a PWM pulse Pwm is received from the PWM pulse generation means 14 as a rotation detection signal Rdet, the rotation detection means 11c judges whether the DC motor 21 is rotating or not.

If a judgment is made (at the time of startup) that the DC motor 21 is not rotating, an acceleration instruction signal Sacc is supplied from the controller 11 to the acceleration time counting means 12 on condition that the speed instruction data Dsp instructs driving of the motor. When a judgment is made that the DC motor 21 is rotating (namely, it is in normal operation), speed instruction data Dsp is supplied from the control means 11 to the PWM duty generation means 13 on condition that the speed instruction data Dsp instructs driving of the motor.

It should be understood that the rotation detection signal Rdet could be any signal that indicates rotation of the DC motor 21, so that a pulse generation signal Ipwm can be used for this purpose.

The acceleration time counting means 12 sets up N (N≧1) sequential acceleration stages, for example three acceleration stages S1-S3, in the acceleration period and outputs an acceleration stage data Das associated with the acceleration stages S1-S3. Upon receipt of an acceleration instruction signal Sacc, the acceleration time counting means 12 starts counting the time that has elapsed since the beginning of the acceleration period to output the acceleration stage data Das (integers 1-3 for example) over the respective prescribed times T1-T3 for the respective acceleration stages S1-S3. The numerical acceleration stage data Das (e.g. integers 1-3) representing the respective acceleration stages S1-S3 can be replaced by data similar to the speed instruction data Dsp representing the speed of the DC motor 21. Upon completion of the Nth acceleration stage (e.g. acceleration stage S3), the acceleration time counting means 12 ends outputting the acceleration stage data Das.

When an acceleration stage data Das is supplied, the PWM duty generation means 13 generates a pulse generation signal Ipwm, which is set to increase the duty ratio (D1-D3) of the PWM pulses Pwm in the successive acceleration stages S1-S3. When speed instruction data Dsp is supplied, the PWM duty generation means 13 generates a pulse generation signal Ipwm in accord with the speed instruction data Dsp. The pulse generation signal Ipwm can be any signal that can determine, for example, the timing of rise and fall of a PWM pulse Pwm.

The speed instruction data Dsp may be solely supplied to the PWM duty generation means 13 even when the acceleration stage data Das is not supplied to the PWM duty generation means 13, but the speed instruction data Dsp may be supplied to the PWM duty generation means 13 simultaneously with the acceleration stage data Das. When the speed instruction data Dsp and the acceleration stage data Das are supplied simultaneously, the PWM duty generation means 13 is controlled to prioritize the acceleration stage data Das. When a stop instruction signal Soff is supplied from the controller 11 to the PWM duty generation means 13, the PWM duty generation means 13 stops outputting a pulse generation signal Ipwm, irrespective of whether the acceleration stage data Das and the speed instruction data Dsp are supplied or not.

Since the PWM duty generation means 13 generates a pulse generation signal Ipwm in accordance with the speed instruction data Dsp and the acceleration stage data Das, it is preferable to provide the PWM duty generation means 13 with a lookup table. As an example, given a speed instruction data Dsp in an 8-bit digital form, the lookup table determines the duty ratio of the PWM pulses Pwm such that the duty ratio of the PWM pulses Pwm is zero when the speed instruction data Dsp is less than a predetermined lower limit, but not zero when the speed instruction data Dsp exceeds the lower limit.

In this manner, driving, stopping, and rotational speed of the motor can be controlled by the speed instruction data Dsp supplied from the superior control unit. If there is a nonlinear relationship between the rotational speed of the DC motor 21 and the duty ratio of the PWM pulses Pwm, an apparently different relationship can be established between the speed instruction data and the duty ratio on the lookup table by taking account of the nonlinear characteristic in the lookup table. For example, an apparently linear relationship can be desirably established between the speed instruction data Dsp and the rotational speed of the DC motor 21.

The PWM pulse generation means 14 generates PWM pulses Pwm having a duty ratio in accord with the pulse generation signal Ipwm supplied from the PWM duty generation means 13, and outputs it as a drive signal to the switching transistor 22. In the example shown herein, the PWM pulses Pwm is supplied to the controller 11 as a rotation detection signal Rdet.

Functions of the motor drive control circuit 10 described above can be implemented in hardware as well as in software.

Referring to the flowchart of FIG. 2, along with FIGS. 1 and 3 respectively showing the arrangement and operative conditions of the DC motor drive circuit, operation of an inventive DC motor drive unit will now be described.

The operation starts in step S101, in which speed instruction data Dsp specifying the rotational speed of the DC motor 21 is set in the data register means 11a by the superior control unit.

In each of steps S102 and S103, the data judging means 11b reads out the speed instruction data Dsp from the data register means 11a and compares the speed instruction data Dsp with a predetermined value N1. In step S102, if the speed instruction data Dsp is found to be smaller than the predetermined value N1, the speed instruction data Dsp is not considered to be drive instruction data, thereby executing no startup operation for the DC motor 21. If in this case the DC motor 21 is already in stationary rotation, an action is taken to immediately stop the DC motor 21. If in step S103 the speed instruction data Dsp is again found to be smaller than the predetermined value N1, the procedure returns to step S101 to repeat this operation.

When the speed instruction data Dsp is larger than the predetermined value N1, the procedure proceeds to step S104 through steps S102 and S103, since the speed instruction data Dsp then instructs driving of the motor.

In step S104, it is judged by the rotation detection means 11c whether the DC motor 21 is rotating or not. The rotation of the DC motor 21 is judged, or estimated, based on a determination as to whether PWM pulses Pwm are supplied to the DC motor 21 or not, or whether a pulse generation signal Ipwm has been outputted or not to generate the PWM pulses Pwm. Since the rotation of the DC motor 21 is detected based on, for example, the PWM pulses Pwm, a rotation sensing device such as a tachometer is not required.

When a judgment is made in step S104 that the DC motor 21 is not rotating, the procedure proceeds to an acceleration phase (steps S111-S114), but otherwise the procedure proceeds to a stationary rotation phase (steps S121-S122).

In the example shown herein, the acceleration phase (steps S111-S114) incorporates an acceleration period that includes a first through a third acceleration stages S1-S3 (N=3 in this example), so that the drive unit outputs acceleration stage data Das in the respective acceleration stages S1-S3.

In step S111, acceleration is executed while the acceleration stage number is 0, 1, and 2 in accordance with the respective acceleration stages S1 through S3, and then the procedure proceeds to the stationary rotation stage (steps S121-S122) when the acceleration stage number becomes 3.

The acceleration stage number is 0 at the beginning of a startup. Conditions for the first acceleration stage S1 are set in step S112 (for example, “acceleration time=T1 ms and the duty ratio of the PWM pulses=D1%”). The DC motor 21 is turned on and off (that is, the switching transistor 22 is turned on and off) in step S103 under this acceleration condition.

Development of the acceleration of the DC motor 21 is shown in FIG. 3(a)-(b). The first acceleration stage S1 starts at time t0 with the duty ratio of D1% and lasts a period of T1. The level of the current I provided to the DC motor 21 in the first acceleration stage S1 remains a little higher than the stationary current level Ic of the motor 21 (under duty ratio of 100%). This current I decreases in the course of time from time t0 to t1. At time t1, the first acceleration stage S1 ends. At this point of time t1, the acceleration stage number is incremented by 1 in step S114, that is, the count is incremented from 0 to 1.

When the acceleration stage number is 1, conditions for the second acceleration stage S2 are set (for example, “Acceleration time=T2 ms and duty ratio of PWM pulses=D2%”). The DC motor 21 is driven in step S103 under the acceleration conditions. As seen in FIG. 3(a)-(b), the second acceleration stage S2 starts at time t2 with the duty ratio of D2% and lasts a period of T2. The level of the current I provided to the DC motor 21 in the second acceleration stage S2 also remains a little higher than the stationary current level Ic of the DC motor 21, and decreases in the course of time from t1 to t2. At time t2, the second acceleration stage S2 ends. At this point of time t2, the acceleration stage number is incremented by 1 in step S114, that is, the count is increased from 1 to 2.

When the acceleration stage number is 2, conditions for the third acceleration stage are set (for example, “acceleration period of time=T3 ms and duty ratio of PWM pulses=D3%”). The DC motor 21 is driven in step S103 under the acceleration conditions. It is seen in FIG. 3(a)-(b) that in the third acceleration stage S3 the acceleration starts at time t2 with the duty ratio being D3% and lasts for a period of T3. The level of the current I in the second acceleration stage S2 also remains a little higher than that of the stationary current level Ic of the DC motor 21, and decreases over a period from time t2 to t3. At time t3, the third acceleration stage S3 ends. At time t3, the acceleration stage number is incremented by 1 (step S114), which increases the count from 2 to 3.

When the acceleration stage number is 3, a judgment is made in step S111 whether the third acceleration period has expired or not, and, if it has, the procedure proceeds to the stationary rotation stage. Shortly after time t3 when the motor entered the stationary rotation phase, the level of the current I rises to a level (peak level Ip in the example shown) which is a slightly higher than the stationary current level Ic of the DC motor 21. The current then decreases in time towards the stationary current level Ic.

Specifically, the acceleration times and duty ratios can be set as, for example, “T1=25 ms, D1=65%”; “T2=25 ms, D2=75%”; and “T3=25 ms, D3=85%”. The acceleration times T1-T3 of the respective acceleration stages S1-S3 can be identical or different from one another. However, in order to limit the current I below a certain level, it is necessary to increase the duty ratio (D1-D3) in sequence in the acceleration stages S1-S3 in the order mentioned.

Further, it is preferred that the duty ratio D1 for the first acceleration stage S1 is set independently of the speed instruction data Dsp that is given at the end of the acceleration period so that the motor 21 can overcome the static frictional torque acting on it. Thus, after the acceleration period, the DC motor 21 can be rotated at a low speed in accordance with speed instruction data Dsp no matter whether the speed instruction data Dsp gives 100% duty ratio as shown in FIG. 3 or significantly small duty ratio as indicated by a broken line in FIG. 3(a). Thus, startup capability of the DC motor 21 is improved in the manner as described above, which in turn permits reduction of the minimum permissible rotational speed of the motor.

In the stationary rotation stage (steps S121-S122), the PWM duty generation means 13 and the PWM pulse generation means 14 generate PWM pulses having a duty ratio in accord with the speed instruction data Dsp to control on-off operation of the switching transistor 22. This makes the DC motor 21 to rotate at the speed in accord with the speed instruction data Dsp.

Subsequently, the steps S101 to the stationary rotation step S121 via steps S102-S104 is repeated to keep the DC motor 21 in rotation.

When the speed instruction data Dsp is changed during a steady operation of the DC motor 21, the operating condition of the motor 21 will be changed accordingly. If new speed instruction data Dsp has a value larger than a predetermined value N1, the duty ratio of the PWM pulses Pwm is changed in accordance with the new speed instruction data Dsp, thereby causing the DC motor 21 to continue its rotation at a speed set by the new speed instruction data Dsp.

However, when the new speed instruction data Dsp has a value smaller than the predetermined value N1, the new speed instruction data is not judged in step S102 as giving drive instruction. The procedure further proceeds from step S102 to a stop phase (steps S131-S132), in which speed instruction data Dsp is stopped (step S131), that is, not given to the DC motor 21, and the acceleration stage number is reset to 0 (step S132). Then, steps S101 to the stop phase (steps S131-S132) via step S102 is repeated to sustain the motor in a standby mode.

Thus, drive instruction, speed instruction, and stop instruction are discerned from the magnitude of the speed instruction data Dsp. This implies that an upstream or superior control unit can give the motor drive control circuit 10 instructions on different operating conditions of the DC motor 21 using only the speed instruction data Dsp.

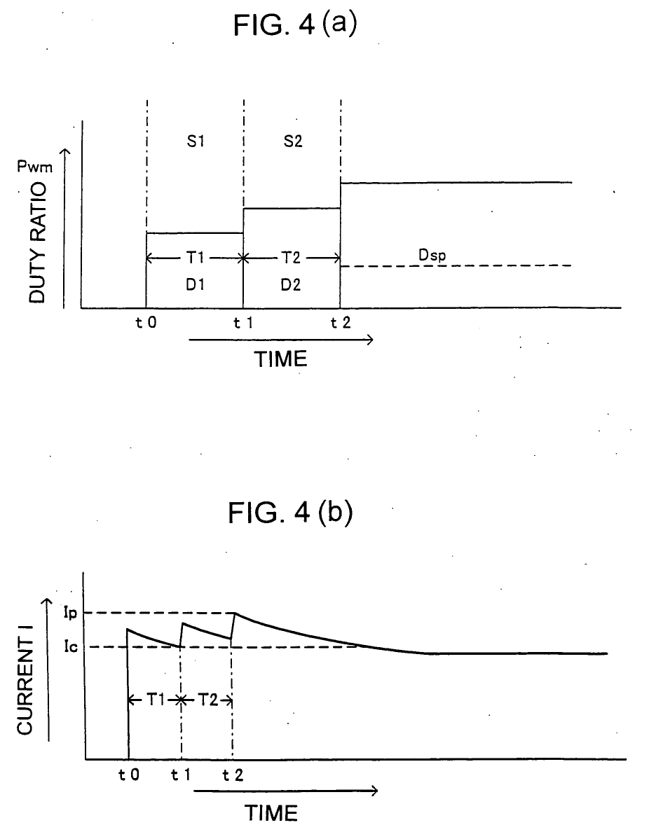

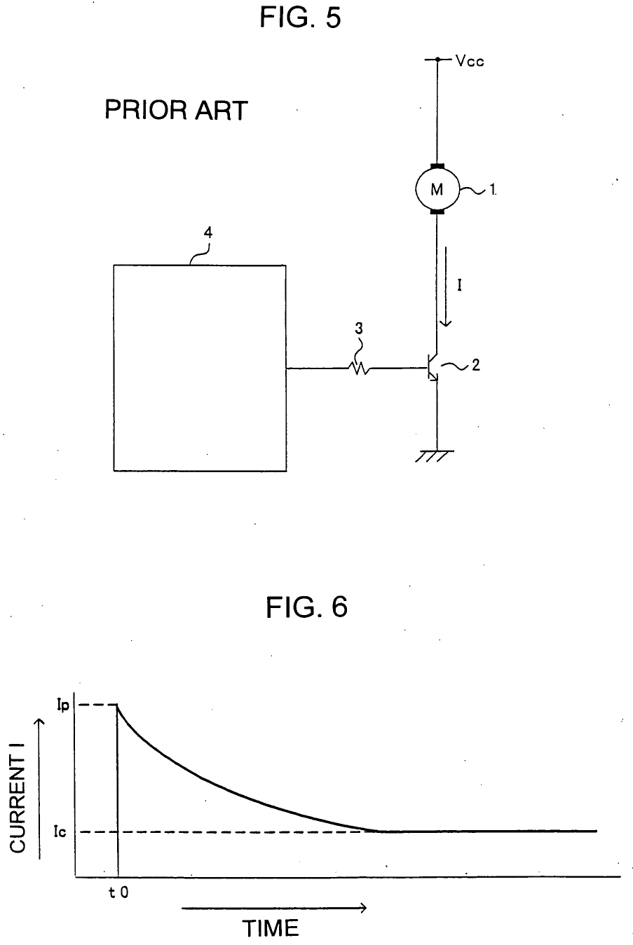

FIG. 4(a)-(b) illustrates operation of a DC motor drive circuit for which N=2, that is, it has an acceleration period associated with two acceleration stages S1 and S2. As seen in FIG. 4, the acceleration period differs from the foregoing example in that it involves only two acceleration stages S1 and S2, but is similar in operation to that described above in connection with FIGS. 1-3. As an example, acceleration times and duty ratios can be set as, for example, “T1=50 ms, D1=60%”, and “T2=50 ms, D2=75%”. The acceleration times T1 and T2 for the respective acceleration stages S1 and S2 can be identical. However, in order to limit the current I below a certain level, it is necessary to increase the duty ratio (D1-D2) in the successive acceleration stages S1-S2.

It will be apparent that the acceleration period can include more than three (N≧4) acceleration stages, or only one acceleration stage (N=1). What kind of acceleration stages be provided for the motor drive unit depends on, for example, the switching transistor 22, DC motor 21, and power source used.

It should be understood that the DC motor 21 could be a brush-type motor or a brushless motor. The switching transistor 22 is not limited to a bipolar transistor, and in fact it can be any switching element that can be switched on and off by a control signal.

### INDUSTRIAL APPLICABILITY

The DC motor drive unit of the invention can control the rotation of a DC motor used in a game controller or a toy to drive and/or vibrate a movable element thereof in accordance with an external speed instruction. The drive unit can suppress the startup current of the DC motor.

1. A DC motor drive unit for driving a DC motor, adapted to control switching means connected in series to said DC motor, said drive unit comprising:
acceleration setting means for setting a predetermined acceleration period and acceleration stage data in association with said acceleration period at the time of startup of said DC motor; and
PWM pulse generation means for generating PWM pulses having duty ratios in accord with said acceleration stage data or in accord with a prescribed rotational speed of the motor, wherein
said switching means is controlled by
the PWM pulses having duty ratios in accord with said acceleration stage data during said predetermined acceleration period; and
the PWM pulses having the duty ratio in accord with said prescribed rotational speed after said predetermined acceleration period.

2. The DC motor drive unit according to claim 1, wherein said acceleration period includes a sequence of N (N≧1) acceleration stages each set to have PWM pulses of a predetermined duty ratio over a predetermined acceleration time, said duty ratio increasing in the successive acceleration stages.

3. The DC motor drive unit according to claim 1, further comprising a data judgment means for judging whether an externally supplied speed instruction data instructs driving of said motor or not, wherein,
when a judgment is made that said speed instruction data instructs driving of said motor, said switching means is controlled by:
the PWM pulses having duty ratios in accord with said acceleration stage data during said predetermined acceleration period; and
the PWM pulses having a duty ratio in accord with the rotational speed instructed by said speed instruction data after said acceleration period.

4. The DC motor drive unit according to claim 3, wherein said acceleration period includes a sequence of N (N≧1) acceleration stages each set to have PWM pulses of a predetermined duty ratio over a predetermined acceleration time, said duty ratio increasing in the successive acceleration stages.

5. The DC motor drive unit according to claim 4, adapted to:
measure the time that has elapsed from the beginning of said sequence of acceleration period to determine the current stage in said acceleration period; and
determine the duty ratio associated with said stage and/or the duty ratio associated with said speed instruction data in accordance with a lookup table.

6. The DC motor drive unit according to claim 4 or claim 5, adapted to execute acceleration of said DC motor in said acceleration period only if a judgment is made that said speed instruction data instructs driving of said DC motor and said motor is not in rotation.

7. The DC motor drive unit according to any one of claims 3-5, adapted to stop said DC motor if a judgment is made that said speed instruction data does not instruct driving of said DC motor.
